(19) United States
(12) Patent Application Publication
(10) Pub. No.: US 2010/0011303 A1
(43) Pub. Date: Jan. 14, 2010

(54) IMAGE DISTRIBUTION DEVICE

(76) Inventor: Masaru Fujii, Tokyo (JP)

Correspondence Address: BACON & THOMAS, PLLC, 625 SLATERS LANE, FOURTH FLOOR, ALEXANDRIA, VA, 22314-1176, US

(21) Appl. No.: 12/310,077

(22) PCT Filed: Jul. 13, 2007
(86) PCT No.: PCT/JP07/64383

§ 371 Date: Feb. 10, 2009

(30) Foreign Application Priority Data
Aug. 10, 2006 (JP) 2006-217773

(51) Int. Cl. G06F 3/01; G06F 15/16

(52) U.S. Cl. 715/760; 709/217

(57) ABSTRACT

A display information distribution device distributing display information effectively distributes display information in a plurality of languages. The display information distribution device includes storage means having a language setting unit for setting a value specifying one of languages and character information for each of the languages and containing format information as display information for displaying character information on the language corresponding to the value when one is set at the language setting unit; reception means for receiving the specification of one of the languages; generation means for setting the value corresponding to the received specification on the language setting unit of the format information to generate display information; and distribution means for distributing the generated display information.

### FIELD OF THE INVENTION

The present invention relates to a display information distribution device that distributes display information; and, more particularly, to a display information distribution device that effectively distributes display information in multiple languages.

### BACKGROUND OF THE INVENTION

Conventionally, a monitoring image distribution device of a network type (WEB encoder) provides a graphical user interface (GUI) that enables the user to check monitoring images or set a monitoring device through web pages. More particularly, a GUI for checking monitoring images is provided through a web page for image display, and a GUI for setting the monitoring device is provided through a web page for setting.

Data for the web page is stored in a memory in the WEB encoder. The user uses a web browser running on a personal computer or the like to send a request for a web page to the WEB encoder, and the WEB encoder transmits the requested web page to the user.

Here, to change a language displayed on a web page, it is necessary for the WEB encoder to separately prepare web page data recorded in multiple languages. In addition, since the capacity of the memory in the WEB encoder is generally small and the memory tends to have a capacity with which web page data corresponding to only one language can be stored, the contents of the memory need to be rewritten to change the display language.

Although the present inventor has recognized that the above-mentioned technology is well known in the art, but he cannot find any relevant document and therefore, the specification does not disclose information about relevant technical documents.

In the above-mentioned WEB encoder, in order to display a web page in different language from a current language, a developer needs to manually prepare webpage data (conversion of strings in use to another language or change of character codes) for language addition and also needs to directly perform memory rewriting on the memory of the WEB encoder for the language conversion. This process requires a lot of time and effort. Further, whenever data of web pages is modified, the web page data in all languages need to be modified, in which case much effort is required and additional time is required for confirmation of the data modification.

### SUMMARY OF THE INVENTION

In view of the above, the object of the present invention is to provide a display information distribution device that effectively distributes display information written in multiple languages.

In accordance with an aspect of the present invention, the above and other objects can be accomplished by the provision of a display information distribution device that distributes display information with a following configuration.

Storage means stores format information of display information. The format information includes a language setting part for setting a value determining one of multiple languages in the information, character information for each of the languages. If the language setting part is set with the value, the format information functions as a display information for displaying character information in a language corresponding to the value.

Reception means receives data determining one of the languages. Generation means sets the value corresponding to the data determining one of the languages, which is received by the reception means, into the language setting part of the format information stored in the storage unit to generate display information. Distribution means distributes the display information generated by the generation means.

Accordingly, display information is generated by preparing the format information corresponding to the multiple languages in advance and setting a value corresponding to the data determining one of the languages to the format information, so that the display information of the multiple languages is effectively distributed even when demand for display information determining the language is made at various times.

Here, various formats or contents may be used as display information or its format information. For example, information in a web page may be used.

Further, various languages may be used and the number of languages may be variously determined. Further, although character data for the respective languages that have the same (or similar) meaning are used as the character information included in the format information and/or display information, other types of character data may be used.

Further, for example, as English characters are used in a Japanese content, since character information of a specific language may partially includes information of another language, the present invention covers this case. As a detailed example, even when an English title is contained in a Japanese content, if it is displayed to a user desiring Japanese, the total contents are regarded as Japanese display information.

Further, in reception of data determining one of the languages, the data may be received from an external device (a device other than the display information distribution device), or the display information distribution device may receive that from a user. For example, the data determining one of the languages may be received when a request for distribution of the display information is made, or the language determination contents are received in advance to be stored in a memory in the display information distribution device.

When a plurality of devices to which display information is distributed exists, a desired language may be determined for each of the devices (for example, identification information of the devices) and display information may be generated so that each device can use the determined language by identifying the device. When there is a plurality of users that manipulate one or more devices to which display information is distributed, a desired language may be determined for each user (for example, identification information of the user) and display information may be created so that the user can use a determined language by identifying the user.

Further, various structures are possible for a system distributing display information to a device of a distributed site by a display information distribution device.

The device of a distributed site includes, for example, means for determining a desired language to a display information distribution device, means for requiring desired display information from the display information distribution device, means for receiving display information transmitted from the display information distribution device, means for storing the received display information in a memory, and/or means for displaying the contents on a screen based on the received display information.

The display information distribution device in accordance with the present invention has a following configuration.

The format information separately includes external information and main information. The external information has character information for each of the languages, and main information has information other than the information in the external information and having an instruction for referring to the information in the external information.

Accordingly, character information for multiple languages is contained in the external information, and character information for the languages that is contained in the external information is referred to by the main information, whereby the same external information may be referred to by a plurality of other main information. Further, once the external information is stored in a device to which the display information is distributed, only the main information needs to be distributed for other display information by using the stored external information, thereby improving efficiency. Further, when the character information of multiple languages that is contained in the external information is changed (for example, without changing the main information), only the external information may be changed, thereby improving efficiency.

Here, external information and main information may be variously configured with by using format information and display information.

The information contained in the external information may be various.

Further, the device of the distributed site includes means for receiving main information or external information received from the display information distribution device, means for storing the received information or external information in memory, and/or means for displaying the contents on a screen based on the received main information or external information. For example, it is possible to read and use the external information that has been received and stored.

Here, the present invention can provide a method, a program, and a storage medium.

In the method in accordance with the present invention, various means of the device or system execute various processes.

The program in accordance with the present invention is executed in a computer forming a device or a system, and various functions of the program are realized by the computer.

In a storage medium in accordance with the present invention, a program is readably stored by input means of a computer forming a device or a system, and the computer executes various processes of the program.

### BRIEF DESCRIPTION OF THE DRAWINGS

FIG. 1 is a view illustrating a networked monitoring image distribution system in accordance with an embodiment of the present invention.

FIG. 2 is a view illustrating an example of a WEB encoder.

FIG. 3 is a view illustrating an example of the format of a web page.

FIG. 4 is a view illustrating an example of a web page.

FIG. 5 is a view illustrating an example of displaying a web page.

FIG. 6 is a view illustrating an example of displaying a web page in Japanese.

FIG. 7 is a view illustrating an example of displaying a web page in English.

### DETAILED DESCRIPTION OF THE EMBODIMENTS

Embodiments of the present invention will be described with reference to the accompanying drawings.

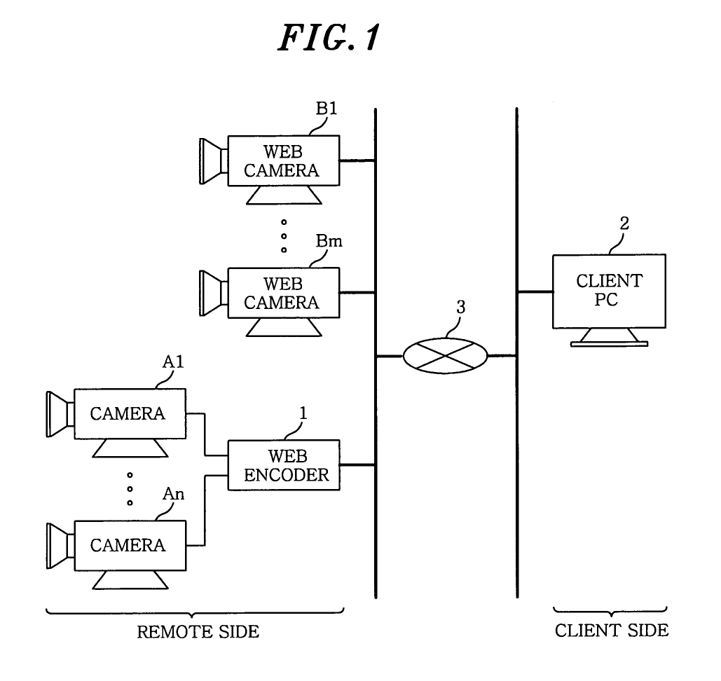

FIG. 1 illustrates a monitoring image distribution system of a network type in accordance with an embodiment of the present invention.

The networked monitoring image distribution system in accordance with the embodiment of the present invention includes n cameras A1 to An, a WEB encoder 1 common to the n cameras A1 to An, m WEB cameras B1 to Bm, a client unit 2 including, such as a personal computer PC, and a network 3.

Here, the cameras A1 to An are connected to the WEB encoder, and the WEB encoder 1, the WEB cameras B1 to Bm, and the client unit 2 are connected to the network 3.

The cameras A1 to An, the WEB encoder 1, and the WEB cameras B1 to Bm are provided at sites remote from the client unit 2.

In the embodiment in accordance with the present invention, n cameras A1 to An and m WEB cameras B1 to Bm are illustrated, but one camera and/or one WEB camera may also be used.

The embodiment of the present invention realizes a network corresponding to a monitoring system in which the WEB encoder 1 and the WEB cameras B1 to Bm are operated as a monitoring device for keeping and distributing monitoring data such as images or voices taken by cameras in order to monitor an intruding object and/or observe a specific point at remote multi-sites, the client unit 2 is operated as a terminal for receiving, displaying, and/or keeping monitoring data, and the WEB encoder 1, the WEB cameras B1 to Bm, and the client unit 2 are connected to each other through the network 3.

The cameras A1 to An are installed at places where target monitored regions are photographed to simultaneously take monitoring images and voices, and transmit the obtained images and/or voices to the WEB encoder 1.

In the WEB encoder 1, data for web page, such as a web page for image display which provides a GUI for checking monitoring images or a web page for setting which provides the GUI for setting a monitoring device and the like, are stored in a memory. The WEB encoder 1 has a function of distributing the data for web page via the network 3 (function of a web server). For example, the WEB encoder 1 distributes monitoring data containing monitoring images or voices received from the cameras A1 to An to the web page for image display.

Each of the WEB cameras B1 to Bm integrally has a function of a camera and a function of a WEB encoder. In the embodiment of the present invention, although a process executed by the cameras A1 to An and the WEB encoder 1 will be described in detail, the same process may be executed by the WEB cameras B1 to Bm.

The network 3 may be realized, for example, a local area network (LAN) or the Internet.

The client unit 2 has a function of a web browser, receives data for web page via the network, analyzes the received data for the web page by using the function of the web browser, and displays the analyzed data on a screen such as a display or an NTSC monitor.

In the embodiment of the present invention, the user manipulates the client unit 2 to request desired web page data from the WEB encoder 1 via the network 3, and the WEB encoder 1 distributes the requested data for web page to the client unit 2 via the network 3. Accordingly, the client unit 2 acquires data for the web page for image display so that the user may view monitoring images and hear voices, or acquire setting data for the web page for setting the monitoring device (WEB encoder 1 in the embodiment of the present invention).

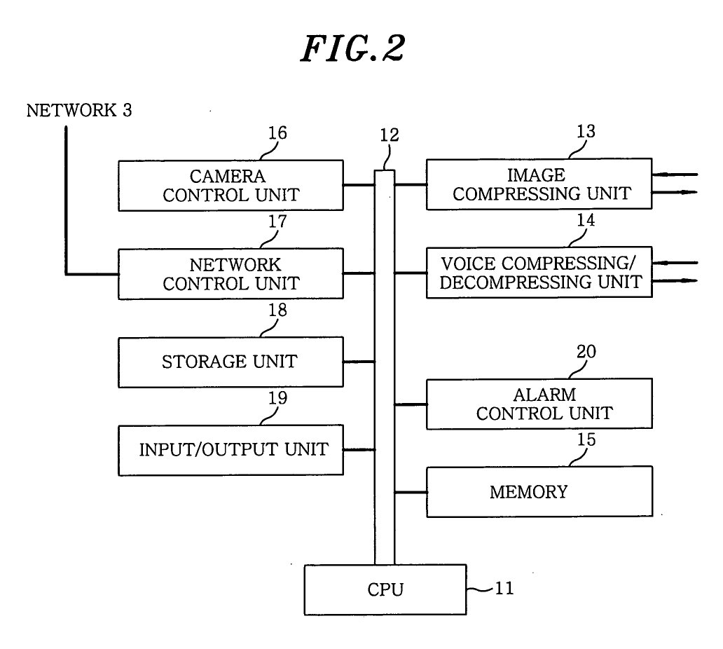

FIG. 2 illustrates an example of a WEB encoder 1.

The WEB encoder 1 in accordance with the embodiment of the present invention includes a central processing unit (CPU) 11, a bus 12, an image compressing unit 13, a voice compressing/decompressing unit 14, a memory 15, a camera control unit 16, a network control unit 17, a storage unit 18, an input/output unit 19, and an alarm control unit 20.

Here, the processing units 11 and 13 to 20 are connected via the bus 12, and the network control unit 17 is connected to the external network 3.

The CPU 11 controls the processing units 13 to 20 that are connected via the bus 12 and performs various functions of the WEB encoder 1.

The image compressing unit 13 compresses the images received from the cameras A1 to An. The compression method for the images may be the JPEG method or the MPEG method or the like, and the images may not be compressed. When voices accompany with the images, the image compressing unit 13 also processes the voices together with the images.

The voice compressing/decompressing unit 14 compresses signals inputted from a microphone, and decompresses the compressed signals of the voice data received from the network 3. Accordingly, in the embodiment of the present invention, the user can execute bi-directional voice communications between the WEB encoder 1 and the client unit 2 on the network 3. Various methods may be used as the compression method of voices, and voices may not be compressed.

In the memory 15, data for web page or various set values are memorized, and various executable programs are memorized to be sequentially read and executed.

The camera controller 16 controls the cameras A1 to An connected to the WEB encoder 1. The WEB cameras B1 to Bm (the camera integrated WEB encoder) are self controlled.

The network controller 17 recognizes the protocols of the network, and transmits and receives data to and from the network 3.

The recorder 18 stores image data, voice data, or various information processed in the monitoring device (WEB encoder 1 in the embodiment of the present invention) in a storage region, and selectively reads out stored image data or voice data by a request from the CPU 11. For example, the storage unit 18 may be any randomly accessible storage medium, such as a hard disk, a digital video disk (DVD), or other memories.

The input/output unit 19 inputs and outputs signals via a serial or contact terminal. For example, the input/output unit 19 is connected to the cameras A1 to An to output signals for controlling the cameras A1 to An and is connected to an external sensor to input information detected by the sensor.

The alarm control unit 20 transmits alarm information to the client unit 2, for example, when specific information is inputted from an external sensor. The alarm control unit 20 receives or renews alarm information.

Hereinafter, distribution of data for web page that is executed by the WEB encoder 1 in accordance with the embodiment of the present invention will be described in detail.

The WEB encoder 1 stores web page format data common to multiple languages corresponding to the data of the web page to be converted and distributed in the plurality of languages. Upon receipt of the request from the client unit 2, parameter values, which determine a language corresponding to the request, are set to the web page format data and the set data for the web page is distributed (transferred) to the requesting source, i.e. the client unit 2. Accordingly, the language of the web page is converted into the language of the web page data distributed from the WEB encoder 1 to the client unit 2.

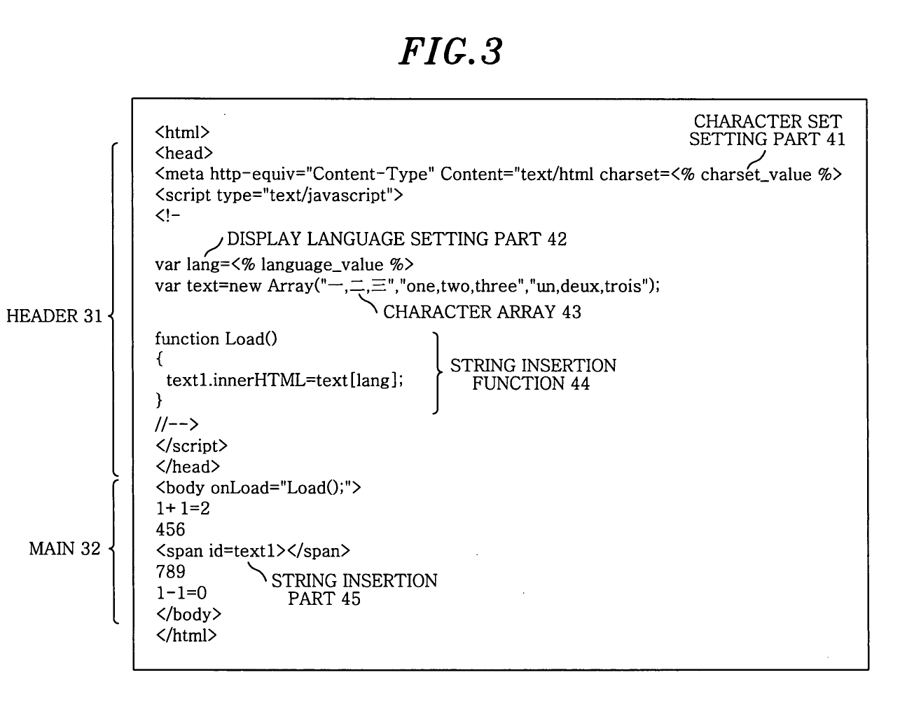

FIG. 3 illustrates an example of the web page format data before setting the parameter values thereto. The data is configured as a file of the hyper text mark-up language (HTML) format.

The web page format data mainly includes a header 31 and a body 32.

The header 31 includes a character set setting part 41, a display language setting part 42, a character array 43, and a string insertion function 44.

Objects to be displayed, such as “1+1=2”, “456”, “789”, and “1−1=0”, are described in the body 32, and a string insertion part 45 is also described in the body.

The display language setting part 42 sets a value for determining the language used in a web page display (display language setting value). In this example, Japanese is selected when the display language setting value is 0, English is selected when the display language setting value is 1, and French is selected when the display language setting value is 2. That is, one of the three languages can be determined in the example.

The character set setting part 41 sets a value for determining a character set used in the web page display. A proper character set is used for each language, e.g., “shift_jis” is used for Japanese.

Herein, a value of the display language setting part 42 or a value of the character set setting part 41 is not set in the web page format data.

Strings to be displayed for respective languages are described in the character array 43. In the embodiment of the present invention, strings in three languages are described in an array. A Japanese string, [symbol] is described as a first item of the character array 43, an English string, “one, two, three” is described as a second item of the array 43, and a French string, “un, deux, trois” is described as a third item of the character array 43.

A sentence, text1.innerHTML=text[lang] is described as the string insertion function 44. The sentence is an instruction for substituting text[lang] for text1, and the value of lang is the display language setting value. In the embodiment of the present invention, when the display language setting value is 0, the first item of the character array 43 is directed to be read and, thus, the Japanese string is read and displayed because of text [0]= [symbol] When the display language value is 1, the string of the second item of the character array 43 is directed to be read and, thus, the English string is read and displayed because of text[1]=“one, two, three”. When the display language value is 2, the third item of the character array 43 is directed to be read and, thus, the French character string is read and displayed because of text[2]=“un, deux, trois”.

“body onLoad” in the body 32 is an instruction for executing processing (processing for display in the embodiment of the present invention) when a web page is read to thereby be strated.

The string insertion part 45 for inserting a string inserts a string determined by the string insertion function 44 in the embodiment of the present invention.

As an example, the language of a web page desired by the client unit 2 is determined by the client unit 2 when the client unit 2 requires the web page data to the WEB encoder 1, and the WEB encoder 1 creates the data for the web page in the determined language and distributes the data to the client unit 2. As another example, correspondence of the language of a web page desired by the client unit 2 to information identifying the client unit 2 is memorized in the memory 15 in the WEB encoder 1 in advance. Then, the WEB encoder 1 detects the language desired by the client unit 2 based on the memorized contents when the client unit 2 requires web page data, creates web page data to correspond to the language desired by the client unit 2, and distributes the web page data to the client unit 2.

As in the case where the language is determined by the display language setting value of the display language setting part 42, the character set determined by the character set setting part 41 may be set in the WEB encoder 1 when the client unit 2 sends an arbitrary request thereto. However, one character set is set in advance for each language in the present example and the WEB encoder 1 sets the value of the character set setting part 41, so that the character set corresponding to the language desired by the client unit 2 can be used.

In addition to the character set, a style sheet determining the sizes and widths of characters or a layout may be an object to be converted for each language.

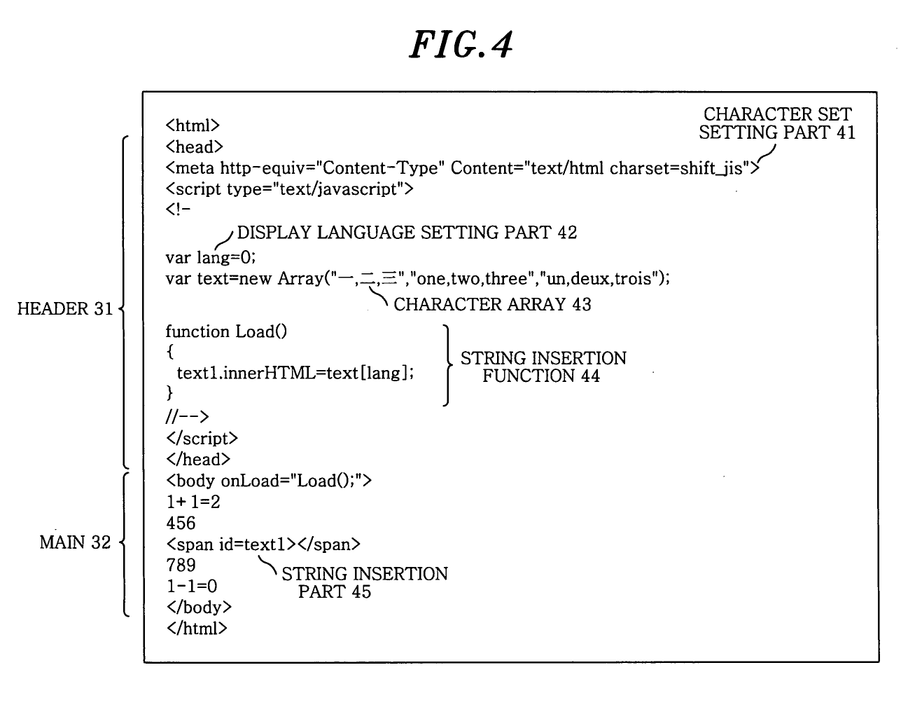

FIG. 4 illustrates an example of web page data after a parameter value is applied.

In the example of FIG. 3, with respect to the web page data format illustrated in FIG. 3, a display language value is set in the display language setting part 42 by the WEB encoder 1 and a character set value is set in the character set setting part 41. In detail, since Japanese is chosen by the client unit 2, a value determining Japanese, i.e., 0, is set in the display language setting part 42, and a character set suitable for Japanese, i.e., shift_jis, is set in the character set setting part 41.

The web page data illustrated in FIG. 3 is data transmitted from the WEB encoder 1 to the client unit 2 and is source data to be displayed on a web browser.

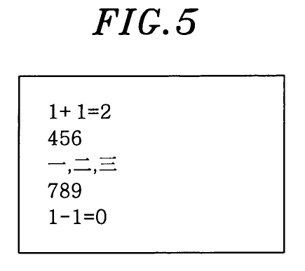

FIG. 5 illustrates contents displayed on a screen obtained by compiling the web page data shown in FIG. 4 by the web browser of the client unit 2.

In detail, the characters of “1+1=2” and “456” the determined Japanese string, [symbol] and the characters of “789” and “1−1=0” are sequentially displayed.

Here, an example of operations executed by the client unit 2 and the WEB encoder 1 when the client unit 2 acquires the web page data by requiring it from the WEB encoder 1 is described.

In this example, the language desired by the client unit 2 is Japanese, and information determining the desired language is memorized in advance in the memory 15 in the WEB encoder 1 by a pre-setting executed by the client unit 2.

First, in the client unit 2, a web browser starts to operate by a user manipulation, and a request for a desired web page is sent to the WEB encoder 1. Thereafter, the WEB encoder 1 searches for and reads the web page format data of the web page requested by the client unit 2 from a multiplicity of the web page format data memorized, i.e., in the memory 15. Then, the WEB encoder 1 reads the preset information determining the language desired by the client unit 2 from the memory 15, and reads the display language setting value or the character set value corresponding to the desired language from the memory 15. A desired display language setting value or character set value corresponding to the information identifying the client unit 2 may be memorized in the memory 15 in advance and may be read.

The WEB encoder 1 adds a character set value (in this example, shift-jis corresponding to Japanese) and a display language setting value (in this example, 0 corresponding to Japanese) corresponding to the desired language which are respectively read from the memory 15 to the character set setting part 41 and the display language setting part 42 in the requested web page format data. Then, the obtained web page format data is transmitted to the client unit 2.

The client unit 2 receives the web page data transmitted from the WEB encoder 1, compiles the data by the web browser, and displays the compiled data.

In detail, when the web page data is received by the client unit 2 and is read by a web browser, an event handler is generated by an onload for the web page driving and processing of the string insertion function 44 (processing of “Load ( )” in FIG. 4) is executed. In this function, the innerHTML inserts an item in the determined language from the character array 43 into each location indicated by the “id” (“text1” of the string insertion part 45 in the example of FIG. 4) in the body 32. The character array 43 is an array and an item number of the character array 43 is determined by the value of the display language setting part 42, so that a string to be inserted [symbol] corresponding to Japanese in the present example) can be determined. As a result, contents of a web page are displayed in a desired language in the web browser on the client unit 2.

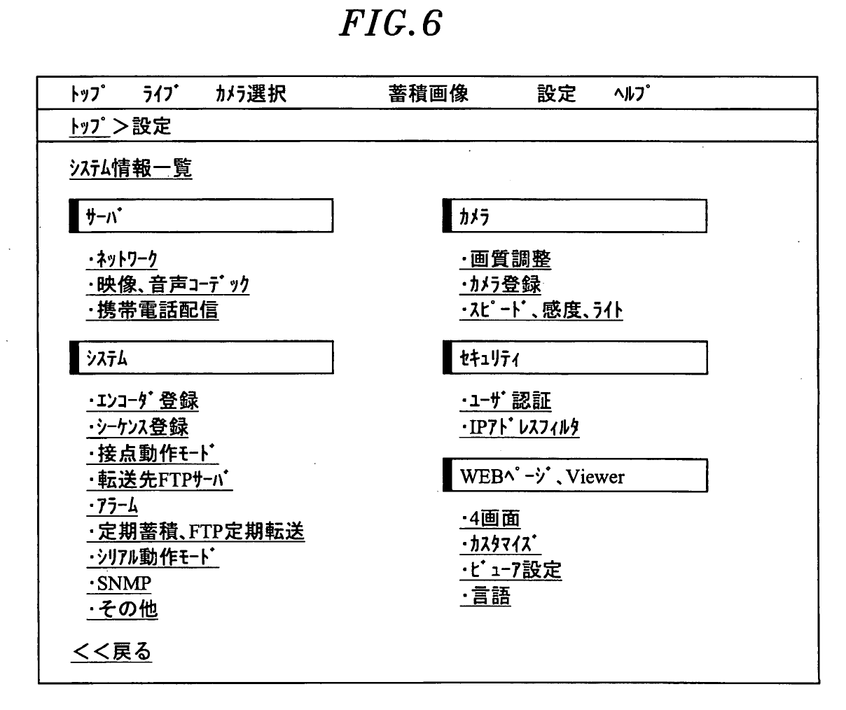

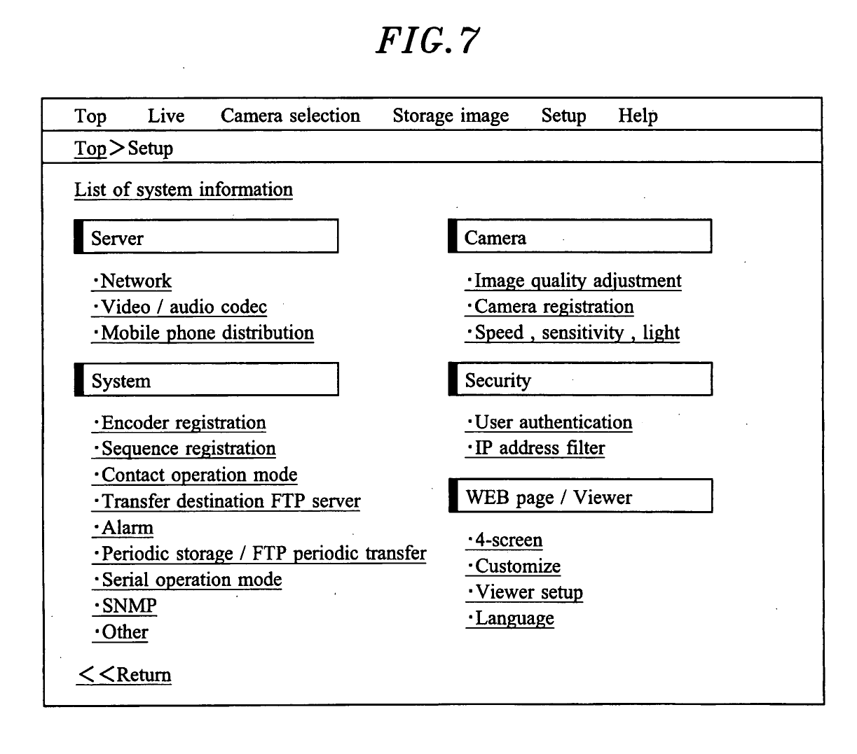

Each of FIGS. 6 and 7 illustrates an example in which the present example converting between of multiple languages is applied to a setting screen of the WEB encoder 1 for monitoring.

FIG. 6 illustrates an example of the contents of a setting screen displayed based on the web page data in which Japanese is determined to be the requested language for the web page format data.

FIG. 7 illustrates an example of the contents of a setting screen displayed based on the web page data in which English is determined to be the requested language for the web page format data.

In the examples of the two web pages, Japanese character strings (although some English characters are included in Japanese display, but they are regarded as Japanese) and its corresponding English character strings are converted therebetween.

When the language of a plurality of character strings is converted, for example, the number of the character arrays 43 illustrated in FIGS. 3 and 4 corresponds to the number of the plurality of character strings.

Here, although a web page is converted into the three languages (Japanese, English, and French) in the embodiment of the present invention, the number of converted languages is arbitrary. For example, the number, of converted languages may be 2 or more than 3. Further, various languages may be used as the converted languages. The number of items of the character array 43 illustrated in FIGS. 3 and 4 may increase or decrease depending on the number of converted languages.

Although the character data is displayed on a web page in the embodiment of the present invention, image data such as a graph or a picture may be displayed on a web page, for example, information determining image data to be displayed and their locations in the web page can be described in the web page data.

Further, in an arbitrary situation, a desired language may be set to the WEB encoder 1 by the client unit 2. For example, web page data for setting language information may be memorized in the memory 15 of the WEB encoder 1, the web page data for setting language information may be transmitted from the WEB encoder 1 to the client unit 2 based on a request from the client unit 2, and a language desired by the user of the client unit 2 may be set on the web page.

Further, as a setting of a language and the like, the setting for changing the contents set in the past may be executed as well as an initial setting.

Although a desired language is set by the client unit 2 in the embodiment of the present invention, a desired language may be set by the WEB encoder 1 (or the WEB cameras B1 to Bm) or another device provided in the network 3.

Further, for example, only a manager having identification information such as a password may set language. In this case, the WEB encoder 1 receives input of the identification information such as a password, for is example, from the client unit 2, identifies it, and receives a language setting if properly certified.

In the embodiment of the present invention, although the character arrays 43 of languages are described in the web page data, only parts of the respective character arrays 43 of languages may be described in one or more than two external files collectively, and instructions for using the parts of the respective character arrays 43 described in the external files by referring to the external files may be described in the web page data. In this case, the WEB encoder 1 transmits both the web page data required from the client unit 2 and the data of the external files referred by the web page data to the client unit 2.

When an external file describing parts of the respective character arrays is used, addition and change of languages may be made only to the external file, whereby the character arrays can be easily edited.

Although only character arrays are described in the external file, as described above, character arrays and other information, or information other than the character arrays may be described in the external file and be referenced from a web page.

In the above-described configuration using the external file, for example, common external files may be referred and used by different web pages, and therefore the entire amount of the character arrays to be described can be reduced. Further, for example, when external files are once read by the client unit 2 and memorized in a cache memory, the client unit 2 may read and use the external file memorized in the cache without reading the external file from outside again, thereby improving efficiency.

As mentioned above, in the monitoring image distribution system of a network type in accordance with the embodiment of the present invention, a monitoring image distribution device of a network type (the WEB encoder 1 or the WEB cameras B1 to Bm in the embodiment of the present invention) that distributes monitoring data such as monitoring images or voices via the network 3 converts language (strings of each language in the embodiment of the present invention) for checking monitoring images and/or setting the monitoring image distribution device.

In detail, character strings of multiple languages that can be displayed on a web page are collectively assigned in an array of the character array 43 as a set, character string to be displayed among the character strings of the languages is determined by an item number of the array, and the character string of the determined language is written out by a script such as JavaScript or VBScript. The parts of the web page other than the character arrays for converting languages are common to the languages. In the embodiment of the present invention, the display language setting value corresponding to the client unit 2 is set to the monitoring image distribution device of the network type by using a web page for setting language information, and the item number of the array is determined by the value.

As mentioned above, the embodiment of the present invention provides the web page format data, and the data contain a part (display language setting part 42 in the embodiment of the present invention) capable of assigning a value (display language setting value) to determine (select) one of the languages, and character information for display (the character array 43 in the embodiment of the present invention) for the languages. The value corresponding to the language determined by the client unit 2 is applied in the web page data format, and the contents are displayed by using the web page data applied with the determined language.

Further, in the embodiment of the present invention, it is possible to describe information such as a character string referred by the web page in a file (external file) other than data of the web page.

Therefore, in the monitoring image distribution system in accordance with the embodiment of the present invention, when web pages using respective multiple languages are displayed, character strings converted into the plurality of languages may be described (for example, when another language is added, a character string of the language is added) in the web page data. Further, the language used in a web page may be converted by setting a language in the web page for setting language information. That is, the language of the web page may be converted in a simple procedure as compared with the conventional technology.

In addition, in the networked monitoring image distribution system in accordance with the embodiment with the present invention, when web page data are distributed to a plurality of client units 2 from the WEB encoder 1 (or one of WEB cameras B1 to Bm) to display web pages of the same contents in different languages on the respective client units 2, the web page format data is common between the client units 2 and only the value of the display language setting part 42 and/or the character set setting part 41 may be set depending on the different, thereby improving efficiency.

Further, in the embodiment of the present invention, the display information distribution device is realized by the WEB encoder 1 (or the WEB cameras B1 to Bm), a distribution target unit is realized by the client unit 2, the display information is given as web page data, and format information of the display information is given as web page format data. Furthermore, the main information and external information are configured with web page data and an external file referred by the web page data.

In the WEB encoder 1 (or the WEB cameras B1 to Bm) the present embodiment includes a memory unit having a function of memorizing web page format data in the memory 15, a reception unit having a function of receiving a determined language, for example, from the client unit 2 under the control of the CPU 11, a generation unit having a function of, i.e., under the control of the CPU 11, setting a value (the display language setting value in the embodiment of the present invention, and the character set value is also used) in accordance with the determined language to web page format data and generating web page data in which character information (character arrays in the embodiment of the present invention) of the corresponding language, and a distribution unit having a function of distributing the web page data to the client unit 2 of a request source (target distribution site), i.e., under the control of the CPU 11.

The structure of the system or device of the present invention is not limited to the above-described embodiments, but various structures may be used. The present invention may be implemented in the form of the method or scheme for performing the processes of the present invention, and thus the program for realizing the method and/or the storage medium storing the program can be provided to various systems or devices to implement the present invention.

Further, the application field of the present invention is not limited to the above-described embodiments, but the present invention may be applied to various fields.

Further, the system or device in accordance with the present invention can be configured to have hardware resources including a processor and a memory wherein the processor executes a control program stored in the memory (ROM) to control the various processes of the system or device. Further, each functional unit for performing the corresponding process may be configured as an independent hardware circuit.

The scope of the present invention encompasses a computer-readable storage medium such as a floppy disk (registered trademark) or a CD (Compact Disc) ROM storing therein the above-described control program and the control program itself. In this case, the control program can be loaded to the computer from the storage medium so that the control program can be executed by the processor.

### INDUSTRIAL APPLICABILITY

As mentioned above, in accordance with the present invention, a display information distribution device stores format information corresponding to multiple languages, generates display information by setting a value corresponding to the determined language to the format information, and distributes the generated display information, thereby effectively distributing display information for multiple languages.

1-2. (canceled)

3. An image distribution device for distributing images taken by using a camera by an internet protocol to a client device, comprising:
a storage unit for storing therein web page format data which is format data of a web page for checking images or for enabling setting in the client device, wherein the web page format data includes a header including a character set setting part setting information of determining a character set, an array assigned therein character strings of multiple languages that can be displayed on a web page and a script interpreted by a web browser to display on the web page characters of a language corresponding to the information of determining the character set by referring to the array;
a reception unit for receiving data determining one of the languages;
a generation unit for generating the web page by inserting information of determining the character set corresponding to the data received by the reception unit into the character set setting part of the web page format data; and
a distribution unit for distributing the web page generated by the generation unit.

4. The image distribution device of claim 3, there in the image distribution device is formed as one body with a camera, and
wherein the web page format data has a display language setting part in which a display language value is substituted, the display language value being a number corresponding to the information of determining the character set, and the script has a function which is executed by onLoad event when the web page is read and is used in assigning a character string read from the array by using the number of the display language setting part in innerHTML of an object in which the characters are inserted.
